(19) United States
(12) Patent Application Publication
(10) Pub. No.: US 2006/0114971 A1
(43) Pub. Date: Jun. 1, 2006

(54) Receiver, apparatus for generating despread code, and method of generating despread code

(75) Inventor: Nobuo Muto, Matsumoto-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/272,001

(22) Filed: Nov. 14, 2005

(30) Foreign Application Priority Data
Nov. 30, 2004 (JP) 2004-345447

(51) Int. Cl. H04B 1/707

(52) U.S. Cl. 375/147

(57) ABSTRACT

A receiver receives and demodulates a transmission signal that is modulated in Phase Shift Keying modulation and Direct Sequence Spread Spectrum using a spread code. The receiver includes a signal receiving unit that receives the transmission signal and outputs a received signal; a filter unit through which the received signal outputted by the signal receiving unit passes and is outputted as an outputted signal; a base band unit that is configured to despread the outputted signal based on a corrected despread code. The corrected despread code is generated based on the spread code and a deformation position, the deformation position indicating a position in the spread code at which deformation occurs as a result of the received signal passing through the receiver filter unit.

### CROSS-REFERENCE TO RELATED APPLICATIONS

This application claims priority to Japanese Patent Application No. 2004-345447. The entire disclosure of Japanese Patent Application No. 2004-345447 is hereby incorporated herein by reference.

### BACKGROUND OF THE INVENTION

1. Field of the Invention

The present invention relates to a receiver, an apparatus for generating a despread code, and a method of generating a despread code. More specifically, the present invention relates to a receiver, an apparatus for generating a despread code, and a method of generating a despread code to be used for dispreading a signal that is modulated using a spread code.

2. Background Information

Communication by a direct sequence spread spectrum, which is one form of a spread spectrum, has been widely used. Code Division Multiple Access (CDMA), which is a specific example of application of the direct spread spectrum, is used in a cellular phone system, or a satellite positioning system such as a Global Positioning System (GPS), and the like.

In the direct sequence spread spectrum, transmission data is spread to a wide bandwidth by multiplying the transmission data by a spread code, for example, Pseudo Noise (PN), which has a bandwidth much wider than that of transmission data0. On a reception side, it is possible to demodulate the received data to acquire desired data by dispreading or undoing the spread of the received data using a spread code identical with the spread code used on the transmission side.

In order to perform the despreading, it is necessary to first match the phases of the spread code on the transmission side and those of the spread code generated locally on the reception side. FIG. 12 is a conceptual diagram showing an example of a method of synchronizing signals. A signal C1 indicates a received signal and a signal C2 indicates a spread code generated by a receiver. C1 and C2 are identical in shape (the order in which 0 and 1 appear) and different in phase. C1 and C2 are sampled at the same timing while the phase of C2 is shifted (C2 is moved along a time axis T). For example, when a ratio of the number of sampling points where values of C1 and C2 are identical to the number of all sampling points becomes equal to or larger than a predetermined threshold value, it is determined that C1 and C2 are synchronized.

Time required for this synchronization significantly affects time until a received radio wave is demodulated and decoded to finally acquire necessary data. Thus, a large number of techniques for reducing the synchronizing time have been disclosed.

The code synchronizing operation and the demodulation and decoding of a received signal described above are generally performed on the received signal that was subjected to a processing such as filtering after being inputted from an antenna, rather than on a raw high-frequency received signal. In the received signal that passed through a filter, a high-frequency component which indicates a point of change of a spread code may be deleted, or the waveform may be deformed.

FIG. 13 is conceptual diagrams showing such deformation of a received signal. FIG. 13(a) shows a carrier wave, while FIG. 13(b) shows a spread code, which is shown as “PN code” in FIG. 13b. When the carrier wave and the spread code are combined (multiplied), a waveform shown in FIG. 13(c) is obtained. When this combined wave passes through the filter, the combined wave may be deformed as shown in FIG. 13(d). For example, in some cases, a part showing a steep peak like an A part in FIG. 13(c) does not show a clear peak because a high-frequency component is deleted as indicated by a B part in FIG. 13(d) after the combined wave passes through the filter.

Therefore, when the spread code used locally on the receiving side to demodulate the received signal is the same as the one used on the transmission side to multiply the transmission data, the receiving side may erroneously determine that values from the received signal and the spread code are different when in fact these values would be identical if the received signal were not deformed at the filter. Such an error results in long synchronization time.

In view of the above, it will be apparent to those skilled in the art from this disclosure that there exists a need for improved receiver, apparatus for generating a despread code, and method of generating a despread code, that overcome the problems of the related art. This invention addresses this need in the art as well as other needs, which will become apparent to those skilled in the art from this disclosure.

### SUMMARY OF THE INVENTION

An object of the invention is to provide a receiver, an apparatus for generating a despread code, and a method of generating a despread code that allow the demodulation of a modulated signal to be performed quickly.

A receiver is configured to receive a transmission signal, the transmission signal being modulated in Phase Shift Keying modulation and transmitted in Direct Sequence Spread Spectrum using a spread code. The receiver includes a signal receiving unit that is configured to receive the transmission signal and output a received signal; a receiver filter unit through which the received signal outputted by the signal receiving unit passes and is outputted as an outputted signal; and a base band unit that is configured to despread the outputted signal based on a corrected despread code. The corrected despread code is generated based on the spread code and a deformation position, the deformation position indicating a position in the spread code at which deformation occurs as a result of the received signal passing through the receiver filter unit.

An apparatus is for generating a corrected despread code to be used for demodulating a transmission signal. The transmission signal is modulated in Phase Shift Keying modulation and Direct Sequence Spread Spectrum using a spread code. The apparatus includes a simulation signal generating unit that is configured to generate a simulation signal modulated in Phase Shift Keying modulation and Direct Sequence Spread Spectrum using the spread code; an apparatus filter unit through which the simulation signal generated by the simulation signal generating unit passes and is outputted as an outputted simulation signal; and a corrected despread code generating unit that is configured to compare the simulation signal and the outputted simulation signal and obtain a deformation position which indicates a position in the spread code at which deformation occurs as a result of the simulation signal passing through the apparatus filter unit, the corrected despread code generating unit being further configured to generate a corrected despread code by changing a value of the spread code at the deformation position.

A method of generating a corrected despread code to be used for demodulating a transmission signal includes, where the transmission signal is modulated in Phase Shift Keying modulation and Direct Sequence Spread Spectrum using a spread code, generating a simulation signal modulated in Phase Shift Keying modulation and Direct Sequence Spread Spectrum using the spread code; removing a high-frequency component from the simulation signal and generating an outputted simulation signal; comparing the simulation signal and the outputted simulation signal and obtaining a deformation position, the deformation position indicating a position in the spread code at which deformation occurs as a result of the high-frequency component being removed from the simulation signal; and generating a corrected despread code by changing a value of the spread code at the deformation position.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

The invention will be described with reference to the accompanying drawings, wherein like numbers reference like elements, and wherein:

FIG. 1 is a schematic diagram showing a GPS receiver according to a first embodiment of the invention;

FIG. 2 is a schematic diagram showing a main configuration of the GPS receiver according to the first embodiment of the invention;

FIG. 3 is a schematic diagram showing a main configuration of a PC 50 according to the first embodiment of the invention;

FIG. 4 is a schematic diagram showing a main configuration of the GPS receiver according to a second embodiment of the invention;

FIG. 5 is a schematic graph comparing a simulation signal that does not pass through the filter and a simulation signal that passed through the filter;

FIGS. 6A and 6B are schematic diagrams for explaining the synchronizing process with a corrected despread code;

FIG. 7 is a flowchart of an operation of the GPS receiver according to the first embodiment of the invention;

FIG. 8 is a schematic diagram showing a portable terminal and the like according to a third embodiment of the invention;

FIG. 9 is a schematic diagram showing a main configuration of the portable terminal according to the third embodiment of the invention;

FIG. 10 is a schematic diagram showing a main configuration of a server according to the third embodiment of the invention;

FIG. 11 is a schematic diagram showing a main configuration of the server according to a modification of the first embodiment of the invention;

FIG. 12 is a conceptual diagram showing an example of a method of synchronizing spread codes; and

FIG. 13 is a schematic diagram showing deformation of a received signal.

### DETAILED DESCRIPTION OF THE PREFERRED EMBODIMENTS

According to a first aspect of the invention, a receiver is configured to receive a transmission signal, the transmission signal being modulated in Direct Sequence Spread Spectrum using a spread code. The receiver includes a signal receiving unit that is configured to receive the transmission signal and output a received signal; a receiver filter unit through which the received signal outputted by the signal receiving unit passes and is outputted as an outputted signal; and a base band unit that is configured to despread the outputted signal based on a corrected despread code. The corrected despread code is generated based on the spread code and a deformation position, the deformation position indicating a position in the spread code at which deformation occurs as a result of the received signal passing through the receiver filter unit.

According to the first aspect of the invention, the receiver has the signal receiving unit, the receiver filter unit, and the base band unit. Thus, the receiver can receive a signal modulated in the Direct Sequence Spread Spectrum and subject the signal to demodulation processing.

Although the spread code included in the received signal may be lost or deformed when the received signal passes through the filter unit, the base band unit according to the first aspect of the invention predicts such deformation and generates performs the dispreading based on a corrected despread code, which is obtained by modifying the spread code used on the transmission side. Thus, it is possible to finish synchronization of the two spread codes in a short time.

Therefore, in the receiver according to the first aspect of the invention, it is possible to reduce the time required for demodulating a received signal as compared with the case in which a spread code identical with the spread code on the transmission side is used for the purpose of the despreading.

The receiver according to a second aspect of the invention further includes a storing unit configured to store the corrected despread code.

According to the second aspect of the invention, a corrected despread code is stored in the storage provided in the receiver. Thus, it is unnecessary to add a special structure in the receiver for generating a corrected despread code. Therefore, for example, even in a small receiver such as a cellular phone, it is possible to perform prompt demodulation that uses a corrected despread code.

According to a third aspect of the invention, the receiver includes a communication unit. The receiver is configured to acquire the corrected despread code from an information providing apparatus through a network via the communication unit and store the corrected despread code in the storing unit.

According to the third aspect of the invention, since the receiver has the communication unit, the receiver can acquire a corrected despread code from an information providing apparatus through a network. Therefore, when the corrected despread code is changed, the receiver can acquire a new corrected despread code immediately after the change.

According to a fourth aspect of the invention, the base band unit includes a circuit that is configured to generate the corrected despread code based on the spread code and the deformation position.

According to the fourth aspect of the invention, the corrected despread is generated by a circuit, for example, an Integrated Circuit (IC).

Since a despread code is generated internally by hardware, the receiver according to the fourth aspect of the invention can operate at high speed as compared with the case in which a despread code is generated by a general purpose circuit and a software.

According to a fifth aspect of the invention, the transmission signal is a positioning signal transmitted from a satellite positioning system satellite.

According to a fifth aspect of the invention, the receiver further includes a storing unit configured to store the corrected despread code, and the storing unit is configured to store a corrected despread code for each of satellite positioning system satellites that communicate with the receiver.

According to the sixth aspect of the invention, the corrected despread code is created in advance for each of the satellite positioning system satellites that communicate with the receiver.

Therefore, it is possible to reduce time required for acquiring a satellite positioning system satellite compared with the case in which a spread code, which the satellite positioning system satellite uses for signal transmission, is used as a despread code directly.

In addition, since the corrected despread code is generated by predicting a deformation of a signal that occurs in the receiver to compensate for the deformation, it is also possible to reduce decoding errors. Therefore, it is possible to decode a navigation message included in a received signal more accurately, and improve the positioning accuracy.

According to a seventh aspect of the invention, the receiver further includes an A/D conversion unit that converts the outputted signal to generate a digital signal. The base band unit being configured to despread the digital signal using the corrected despread code.

According to an eighth aspect of the invention, the corrected despread code is generated by inverting a value of the spread code at the deformation position.

An apparatus according to a ninth aspect of the invention is for generating a corrected despread code to be used for demodulating a transmission signal. The transmission signal is modulated in Phase Shift Keying modulation and Direct Sequence Spread Spectrum using a spread code. The apparatus includes a simulation signal generating unit that is configured to generate a simulation signal modulated in Phase Shift Keying modulation and Direct Sequence Spread Spectrum using the spread code; an apparatus filter unit through which the simulation signal generated by the simulation signal generating unit passes and is outputted as an outputted simulation signal; and a corrected despread code generating unit that is configured to compare the simulation signal and the outputted simulation signal and obtain a deformation position which indicates a position in the spread code at which deformation occurs as a result of the simulation signal passing through the apparatus filter unit, the corrected despread code generating unit being further configured to generate a corrected despread code by changing a value of the spread code at the deformation position.

According to the ninth aspect of the invention, since the simulation signal generating unit can generate a simulation signal that is modulated by a spread code identical with that on the transmission side.

In addition, since the apparatus for generating a corrected despread code also has the apparatus filter unit that removes a high-frequency component from the simulation signal, the apparatus for generating a corrected despread code can generate a signal obtained by removing a high-frequency component from the simulation signal. In the outputted simulation signal that passed through this filter unit, a part of the spread code is markedly deformed is caused when the high-frequency component is removed. The spread-code-deformed-position detecting unit compares the simulation signal and the outputted simulation signal to detect deformation position in the spread code.

The corrected despread code generating unit corrects the spread code of the transmission side at a position corresponding to the deformation position to generate a corrected despread code.

A received signal that is received by a receiver passes through the receiver filter in the same manner as described above. Thus, deformation of a spread code occurs in the actual receiver in the same manner.

However, according to the apparatus for generating a corrected despread code according to the ninth aspect of the invention, it is possible to predict deformation of a received signal that occurs in a receiver and generate a corrected despread code so as to compensate for the deformation.

According to a tenth aspect of the invention, the corrected despread code is generated by inverting the value of the spread code at the deformation position.

According to an eleventh aspect of the invention, a method of generating a corrected despread code to be used for demodulating a transmission signal includes, where the transmission signal is modulated in Phase Shift Keying modulation and Direct Sequence Spread Spectrum using a spread code, generating a simulation signal modulated in Phase Shift Keying modulation and Direct Sequence Spread Spectrum using the spread code; removing a high-frequency component from the simulation signal and generating an outputted simulation signal; comparing the simulation signal and the outputted simulation signal and obtaining a deformation position, the deformation position indicating a position in the spread code at which deformation occurs as a result of the high-frequency component being removed from the simulation signal; and generating a corrected despread code by changing a value of the spread code at the deformation position.

According to the eleventh aspect of the invention, it is possible to generate a corrected despread signal and provide a receiver with the corrected despread signal.

According to a twelfth aspect of the invention, the detection of a spread code deformed position is performed according to numerical analysis by a computer program.

Therefore, even when there are a large quantity of simulation signals, it is possible detect deformation positions accurately and in a short time to generate a corrected despread signal.

According to a thirteenth aspect of the invention, the deformation position is obtained by displaying a waveform of the simulation signal and a waveform of the outputted simulation signal.

According to the ninth aspect of the invention, the waveform of the simulation signal and the waveform of the outputted simulation signal are displayed on the display unit. Thus, for example, a person can visually observe and compare the displayed waveforms to detect a deformation position.

As the display, it is possible to use a display connected to a computer, printing on a paper medium, and the like. Thus, it is possible to generate a corrected despread code at low cost.

According to a fourteenth aspect of the invention, the transmission signal is a positioning signal transmitted from a satellite positioning system satellite, and the corrected despread code is generated for each of a plurality of satellite positioning system satellites.

According to a fifteenth aspect of the invention, the corrected despread code is generated by inverting the value of the spread code at the deformation position.

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Preferred embodiments of the invention will be hereinafter explained in detail with reference to the attached drawings and the like.

Note that, since embodiments to be described below are preferred specific examples of the invention, technically preferable various limitations are attached to the embodiments. However, the scope of the invention is not limited to these forms.

### First Embodiment

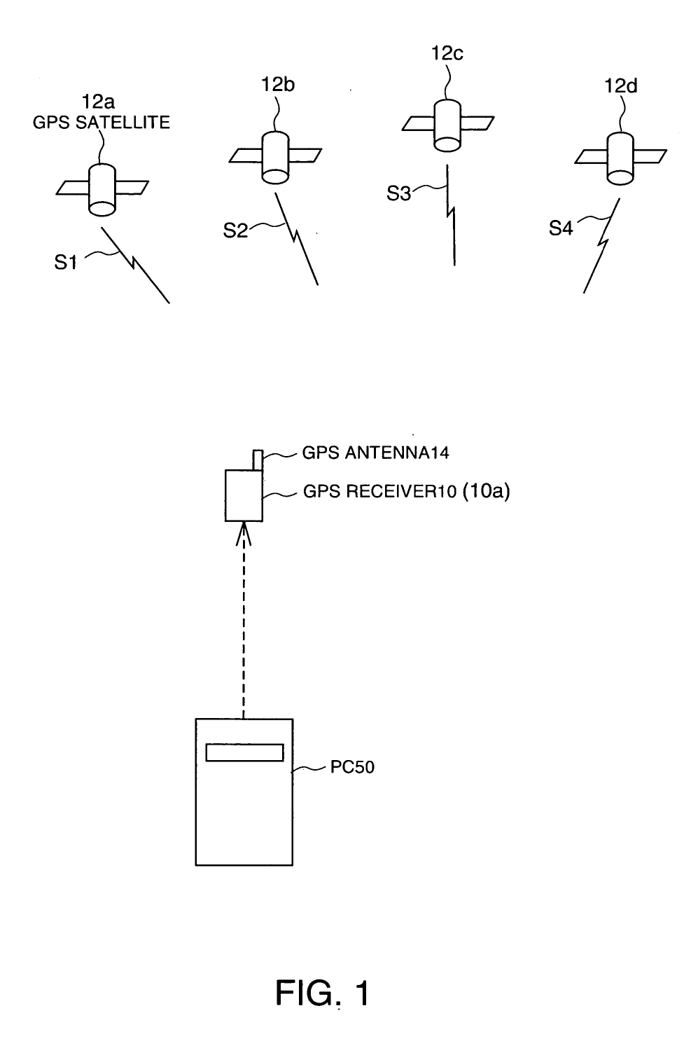

FIG. 1 is a schematic diagram showing the environment in which a GPS receiver 10, which is an example of the receiver, is used.

The GPS receiver 10 has a GPS antenna 14 that is an example of the signal receiving unit. The GPS receiver 10 receives positioning signals S1 to S4 transmitted from GPS satellites 12a to 12d. The signals S1 to S4 are signals in which a 50 Hz navigation message is modulated in Phase Shift Keying modulation and spread in Direct Sequence Spread Spectrum, using a spread code called a C/A (Clear and Acquisition) code over a carrier wave called an L1 band having a frequency of 1.575 GHz. Since the PSK modulation and Direct Sequence Spread Spectrum are well known technologies in the art, further explanation thereof will be omitted herein.

The GPS receiver 10 demodulates and decodes the received signals S1 to S4 to acquire the navigation message and calculates a present location of the GPS receiver 10.

A Personal Computer (PC) 50 is an example of the apparatus for generating a corrected despread code. A despread code generated by the PC 50 is installed in the GPS receiver 10.

Note that the number of GPS satellites that the GPS receiver 10 uses for positioning is not limited to four as shown in FIG. 1. The GPS receiver 10 may use three or less GPS satellites or five or more GPS satellites.

Configuration of the GPS Receiver 10

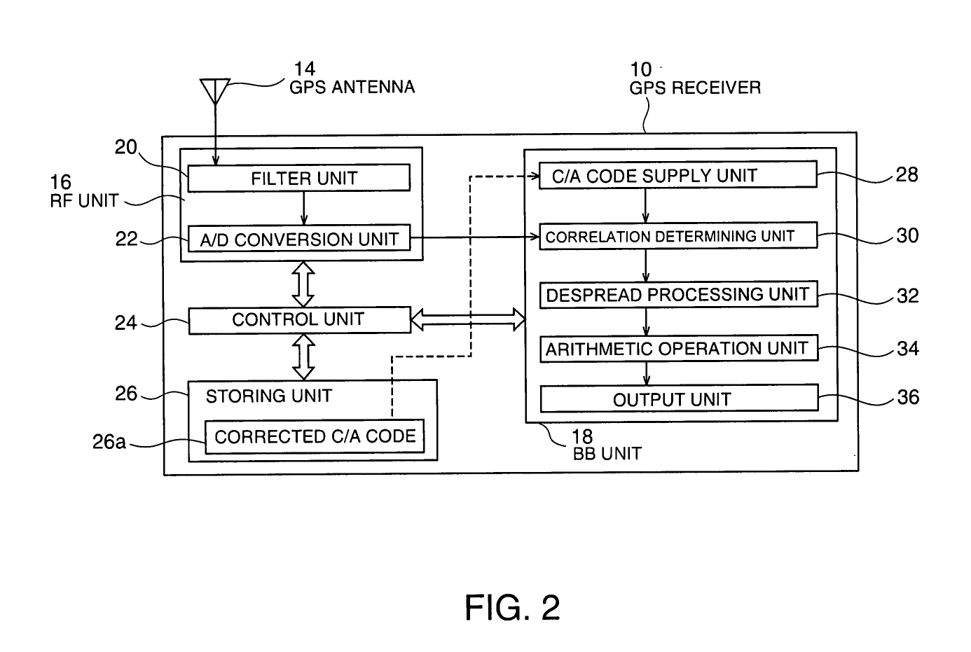

FIG. 2 is a schematic diagram showing a configuration of the GPS satellite 10. In the figure, solid line arrows indicate a flow of signals, a dotted line arrow indicates a flow of data, and void thick arrows indicate a flow of control.

The received signal S1 and so forth received by the GPS antenna 14 are sent to a Radio Frequency (RF) unit 16. The received signal sent to the RF unit 16 is processed into a form suitable for a processing to be performed in a Base Band (BB) unit 18. In the BB unit 18, demodulation, decoding and the like of the signal are performed, such that a navigation message is eventually acquired from the received signal.

A filter unit 20, which is an example of the filter unit, deletes an unnecessary high-frequency component included in the received signal.

An A/D conversion unit 22, which is an example of the A/D conversion unit, converts an analog signal outputted from the filter unit 20 into a digital signal and sends the digital signal to a correlation determining unit 30 of the BB unit 18.

A C/A code supply unit 28, which is an example of the despread code supplying unit, generates a carrier wave having a frequency identical with that of a signal outputted from the A/D conversion unit. Subsequently, the C/A code supply unit 28 combines the generated carrier wave with a corrected C/A code 26a which is stored in a storing unit 26, to generate a despread code. The A code supply unit 28 then supplies the despread code to a correlation determining unit 30.

Characteristics of the corrected C/A code 26a and a method of generating the same will be described later.

The correlation determining unit 30 determines correlation of a signal inputted from the A/D converting unit 22 and a signal inputted from the C/A code supply unit 28. In order to make the determination, the correlation determining unit 30 conducts sampling of, for example, two input signals at the same timing. The correlation determining unit 30 determines that the input signals are synchronized when a ratio of the number of sampling points at which the sampled values are identical to the number of all sampling points is equal to or higher than a predetermined ratio.

When it is determined in the correlation determining unit 30 that the input signals are synchronized, the signals are outputted to a despread processing unit 32. When it is determined that the input signals are not synchronized, the correlation determining unit 30 shifts a phase of a signal outputted by the C/A code supply unit 28 and performs correlation determination again.

The despread processing unit 32, which is an example of the despread processing unit, multiplies a signal outputted from the A/D converting unit 22 and a signal outputted from the C/A code supply unit 28 to demodulate the received signal. Further, the despread processing unit 32 decodes the signal after demodulation to acquire a navigation message. The acquired navigation message is stored in the storing unit 26 if necessary.

An arithmetic operation unit 34 calculates a present location of the GPS receiver 10 based on the navigation message acquired by the despread processing unit 32. The output unit 36 outputs the calculated present location as an image to a display device, which is, for example, a liquid crystal display.

A control unit 24 is embodied as, for example, a microprocessor, and controls operations of the entire GPS receiver 10. The control unit 24 executes an Operating System (OS) and an application program stored in the storing unit 26. The control unit 24 is operatively coupled to the RF unit 16, the storing unit 26, and the BB unit 18, and is configured to selectively send control signals to any of the components connected thereto such as the RF unit 16 to control the components.

The storing unit 26, which is an example of the storage, is embodied as, for example, a Random Access Memory (RAM). The corrected C/A code 26a (an example of the corrected despread code), which the C/A code supply unit 28 uses to generate an despread C/A code, is stored in the storage unit 26. The corrected C/A code 26a does not always have to be generated by the GPS receiver 10. In this embodiment, a corrected C/A code generated by the PC (an example of the apparatus for generating a despread code) 50 to be described later is stored in the storing unit 26 via a recording medium such as a CD-ROM.

Although not shown in the figure, various programs that the control unit 24 executes, data that the arithmetic operation unit 34 uses for calculating a location, and the like are also stored in the storing unit 26.

The corrected C/A code 26a is information indicating a pattern (the order in which 0 and 1 are arranged) of a C/A code over one cycle for all the GPS satellites in operation, for example, all the GPS satellites that communicate with the GPS receiver 10. Since the C/A code is made up of 1023 chips, the corrected C/A code 26a is represented by a binary integer of 1023 bits for one GPS satellite. Therefore, the corrected C/A code 26a is represented as, for example, an array of elements, each of the elements being an integer of 1023 bits, and the number of elements being equal to the number of GPS satellites in operation.

Configuration of the PC 50

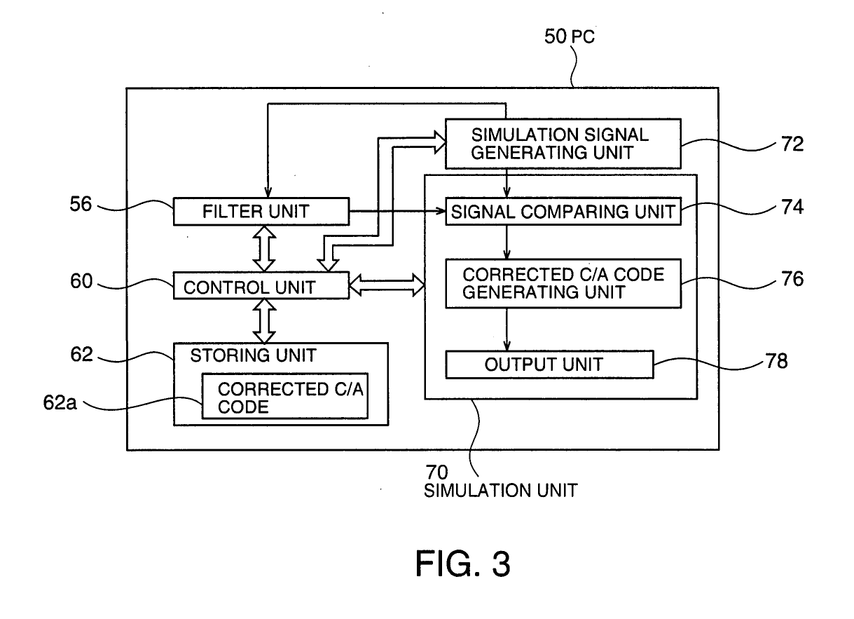

FIG. 3 is a schematic diagram showing a configuration of the PC 50, which is an example of the apparatus for generating a despread code. The PC 50 includes a simulation signal generating unit 72, a filter unit 56, a control unit 60, a simulation unit 70, and a storing u nit 62. Basically, the simulation signal generating unit 72 generates a simulation signal, which is directly passed on to the simulation unit 70. At the same time, the same signal is passed on to the simulation unit 70 via a filter unit 56. The simulation signals are compared in the simulation unit 70 to generate a corrected C/A code 62a.

The filter unit 56 removes a high-frequency component from a signal inputted from the simulation signal generating unit 72. The filter unit 56 is provided for the purpose of finding a spread code deformed position by causing deformation in a simulation signal. Thus, characteristics of the filter unit 56 must be identical with those of the filter unit 20 of the GPS receiver 10, to which a corrected C/A code 62a is supplied.

A control unit 60 is embodied as, for example, a microprocessor, and controls operations of the entire PC 50. The control unit 60 executes an Operating System (OS) and an application program stored in the storing unit 62. The control unit 60 is operatively coupled to the simulation signal generation unit 72, the filter unit 56, the storing unit 26, and the simulation unit 70, and is configured to selectively send control signals to any of the components connected thereto.

The simulation signal generating unit 72, which is an example of the simulation signal generating unit, generates a simulation signal that is used for detecting a deformed part (a broken part) of a C/A code. Specifically, first, the simulation signal generating unit 72 generates a carrier wave having a frequency identical with an intermediate frequency that the GPS receiver 10 to which the corrected C/A code is supplied uses. Then, the simulation signal generating unit 72 generates a simulation signal obtained by subjecting the carrier wave to Binary Phase Shift Keying (BPSK) modulation with a C/A code used by the GPS satellites, and outputs the same simulation signal to the filter unit 56 and a signal comparing unit 74.

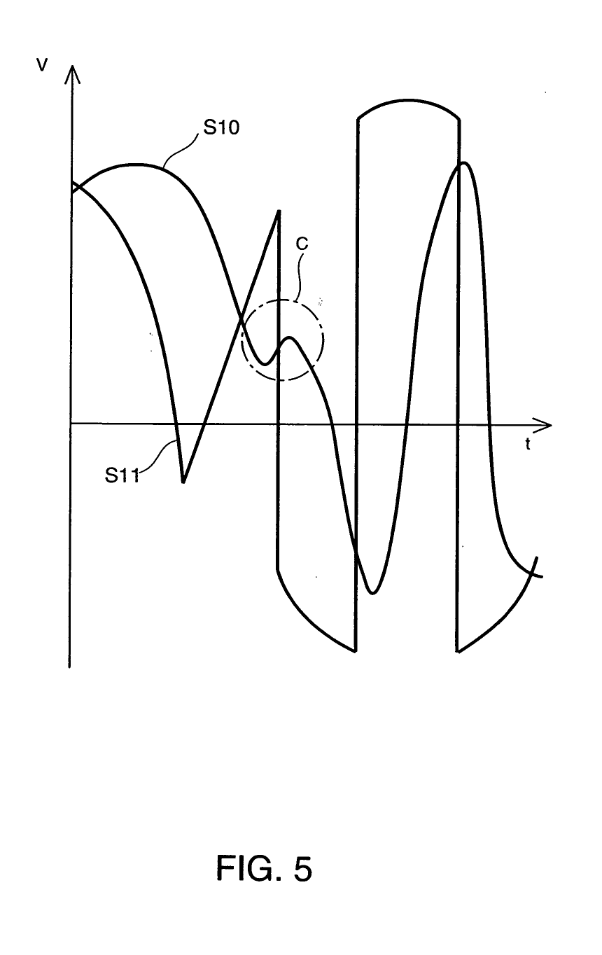

The signal comparing unit 74, which is an example of the spread-code-deformed-position detecting unit, compares a signal that is directly inputted from the simulation signal generating unit 72 and a signal that is inputted through the filter unit 56, and detects a deformed part of the C/A code. FIG. 5 is an example of display of the waveforms.

FIG. 5 is a schematic diagram in which parts of the two input signals are extracted and shown. A signal S11 is a signal directly inputted from the simulation signal generating unit and a signal S10 is a signal that has passed through the filter unit 56. The “deformed part of the C/A code” is a part where a high-frequency component is rounded as the signal passes through the filter unit 56 and a sharp peak, which is originally present in the simulation signal, is lost as indicated by a C part encircled in FIG. 5.

The signal comparing unit 74 detects the deformed part of the C/A code through, for example, numerical analysis by a computer program. When a position of the deformed part is, for example, at a tenth chip from the top of the C/A code, the signal comparing unit 74 outputs a numerical value “10” to the corrected C/A code generating unit 76.

It is also possible that the simulation signal directly inputted and a simulation signal that passes through a filter are displayed as an image on, for example, a display connected to the PC 50, such that a person can visually observe the simulation signals, and the person can perform the detection of the deformed part of the C/A code by comparing the two waveforms.

The corrected C/A code generating unit 76, which is an example of the corrected despread code generating unit, generates the corrected C/A code 62a based on the data indicating the position of the deformed part of the C/A code inputted from the signal comparing unit 74. These data, which is an example of the deformation position, indicate positions in the C/A code at which the deformation occurs as a result of the simulation signal and the C/A code passing through the filter 56. The corrected C/A code 62a is a code obtained by inverting the number of the C/A code used on the transmission side at the chip position of the deformed part. For example, when fourteen chips from the top of a C/A code of a certain GPS satellite are “01110001010011” and the positions of deformed parts of the C/A code are at second, third, and twelfth chips from the top, a corrected C/A code is “00010001010111”.

The corrected C/A code generating unit 76 generates the corrected C/A code 62a of the C/A code over one cycle for all the GPS satellites in operation, and stores the corrected C/A codes 62a in the storing unit 62.

The corrected C/A code 62a generated in this way is supplied to the GPS receiver 10 via a storage medium such as a Compact Disk-Recordable (CD-R).

It is also possible to attach a ROM writer to the PC 50, record a corrected C/A code in a ROM, and supply the corrected C/A code to the GPS receiver 10 or the like.

Since an intermediate frequency used by the GPS receiver 10 and a C/A code used on the transmission side are constant, deformation of the C/A code does not occur irregularly but occurs in a specific portion of one cycle of the C/A code. Therefore, in performing the correlation determination, it is possible to determine the correlation correctly and reduce the time required for synchronizing signals by using as a signal for determination the corrected C/A code 62a rather than the C/A code, which is used on the transmission side.

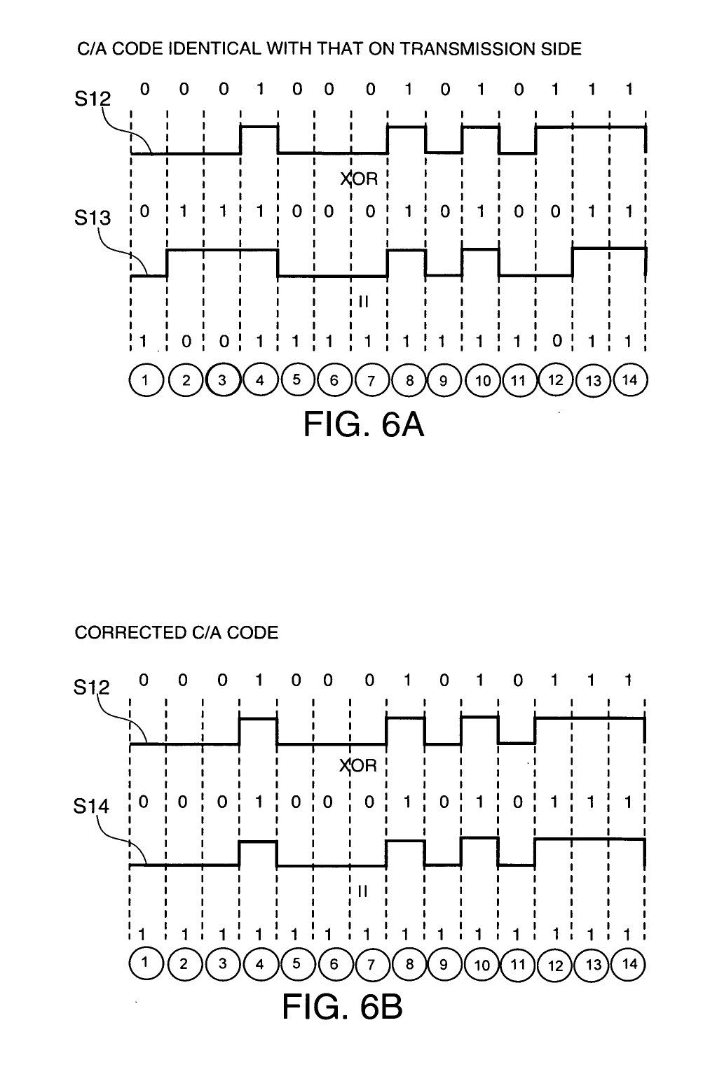

FIGS. 6A and 6B are conceptual diagrams for explaining such effects. FIGS. 6A and 6B show, in the example of the preceding paragraph, a difference between the case in which a C/A code identical with that on the transmission side is used in order to determine correlation (FIG. 6A) and the case in which a corrected C/A code is used in order to determine the correlation (FIG. 6B). A signal S12 is a C/A code that passed through the filter and was deformed, a signal S113 is a C/A code identical with that on the transmission side, and a signal S14 is a corrected C/A code. The numbers at the bottom of each of FIGS. 6A and 6B indicate whether the values of the received signal (S12) coincide with the C/A or corrected C/A signals (S13, S14), “1” indicating that these values coincide, while “0” indicating that they do not.

FIG. 6A shows the case in which a C/A code identical with that on the transmission side is used as a code for the correlation determination. Out of 14 chips, there are eleven chips where the received signal (S12) and the C/A code (S13) coincide with each other, which means that a rate of coincidence is 79% ( 11/14). Where a threshold rate of coincidence for determining that the received signal and the C/A code are synchronized is 80%, it is determined in the case of FIG. 6A that the received signal and the C/A code are not synchronized. Accordingly, the synchronization process is continued by, for example, shifting the phase of the code for determination.

On the other hand, FIG. 6B shows the case in which a corrected C/A code is used. Since the corrected C/A code is created by predicting deformation that occurs as a result of passing a received signal through a filter, the rate of coincidence is 100%. It can be determined correctly that the two signals are synchronized. Thus, it is possible to finish the synchronization process quickly and proceed to the next process.

### EXAMPLE OF MAIN OPERATION OF THE PC 50

The PC 50 according to this embodiment is structured as described above. Next, an example of the main operation of the PC 50 will be explained.

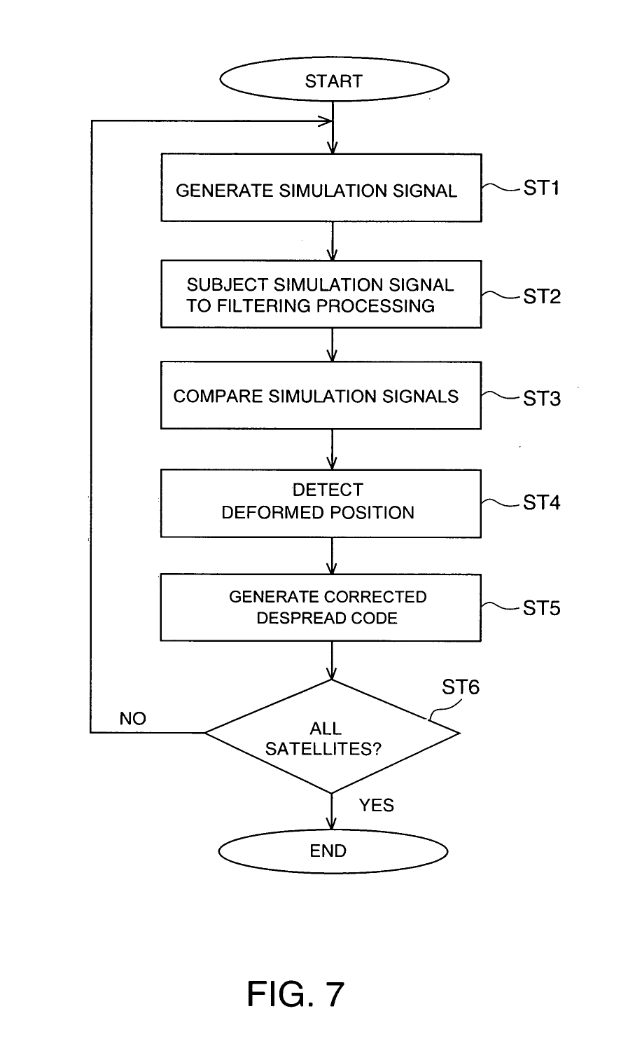

FIG. 7 is a schematic flowchart of an example of the main operation of the PC 50.

The simulation signal generating unit 72 generates a simulation signal (ST1, an example of the generation of a simulation signal). The generated simulation signal is inputted to the filter unit 56, while at the same time the same signal is inputted to the signal comparing unit 74.

The filter unit 56 removes an unnecessary high-frequency signal from the simulation signal inputted from the simulation signal generating unit 72 (ST2, an example of the filtering). The simulation signal that has passed through the filter unit 56 is then inputted to the signal comparing unit 74.

The signal comparing unit 74 receives the simulation signal inputted from the simulation signal generating unit 72 directly and the simulation signal that passed through the filter unit 56, and compares the waveforms of these simulation signals (ST3). The signal comparing unit 74 detects a deformed part in the C/A code (ST4, an example of the detection of a spread code deformed position).

The corrected C/A code generating unit 76 inverts the value of the C/A code at the position of the deformed part to generate the corrected C/A code 62a based on the deformed position in the C/A code detected in ST4 (ST5, an example of the generation of a corrected despread code). The corrected C/A code generating unit 76 stores the corrected C/A code 62a in the storing unit 62.

The PC 50 repeats the steps from ST1 to ST5, generates corrected C/A codes for all the GPS satellites in operation, and stores the corrected C/A codes in the storing unit 62 (ST6). The corrected C/A codes are then supplied to the GPS receiver 10 via a storage medium such as a CD-R, and are stored in the storing unit 26.

Although portions of a C/A code in a GPS signal may be lost or deformed when the GPS signal passes through the filter unit 20, the C/A code supply unit 28 of the GPS receiver 10 can conduct the demodulation based on the corrected C/A, which is generated by predicting such deformation and inverting the value of the C/A code used on the transmission side at the position corresponding to the deformation. Thus, it is possible to finish acquisition of a GPS satellite in a short time.

Therefore, in the GPS receiver 10 according to this embodiment, it is possible to reduce the time required for demodulating a received signal and calculating a location of the GPS receiver 10 as compared with the case in which a C/A code identical with that on the transmission side is used during the demodulation as a despread code.

In addition, since the demodulation of a received signal is performed using a corrected C/A code, it is also possible to reduce decoding errors and improve positioning accuracy.

### Second Embodiment

Configuration of GPS Receiver 10A

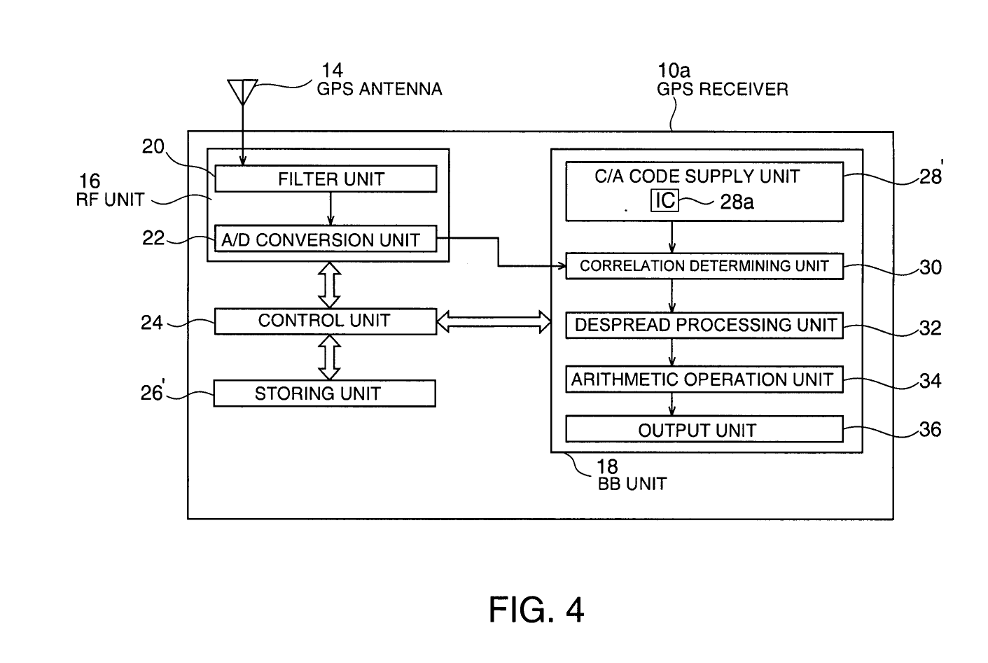

FIG. 4 is a schematic diagram showing a GPS receiver 10a that is in accordance with a second embodiment of the present invention. In view of the similarity between the first and second embodiments, the parts of the second embodiment that are identical to the parts of the first embodiment will be given the same reference numerals. Moreover, the descriptions of the parts of the second embodiment that are identical to the parts of the first embodiment may be omitted for the sake of brevity. The parts of the second embodiment that differ from the parts of the first embodiment will be indicated with a prime (′).

The GPS receiver 10a is different from the GPS receiver 10 in a method with which the C/A code supply unit 28 obtains a corrected C/A code. In the GPS receiver 10a, an IC 28a (an example of the circuit) is incorporated in the C/A code supply unit 28′, such that the IC 28a can generate a corrected C/A code for any GPS satellite in operation.

Since the GPS receiver 10a generates a corrected C/A code with a hardware, the GPS receiver 10a can operate at high speed compared with the case in which the corrected C/A code is generated by software.

### Third Embodiment

Next, a third embodiment of the invention will be explained. In view of the similarity between the first and third embodiments, the parts of the third embodiment that are identical to the parts of the first embodiment will be given the same reference numerals. Moreover, the descriptions of the parts of the third embodiment that are identical to the parts of the first embodiment may be omitted for the sake of brevity. The parts of the third embodiment that differ from the parts of the first embodiment will be indicated with a double prime (″).

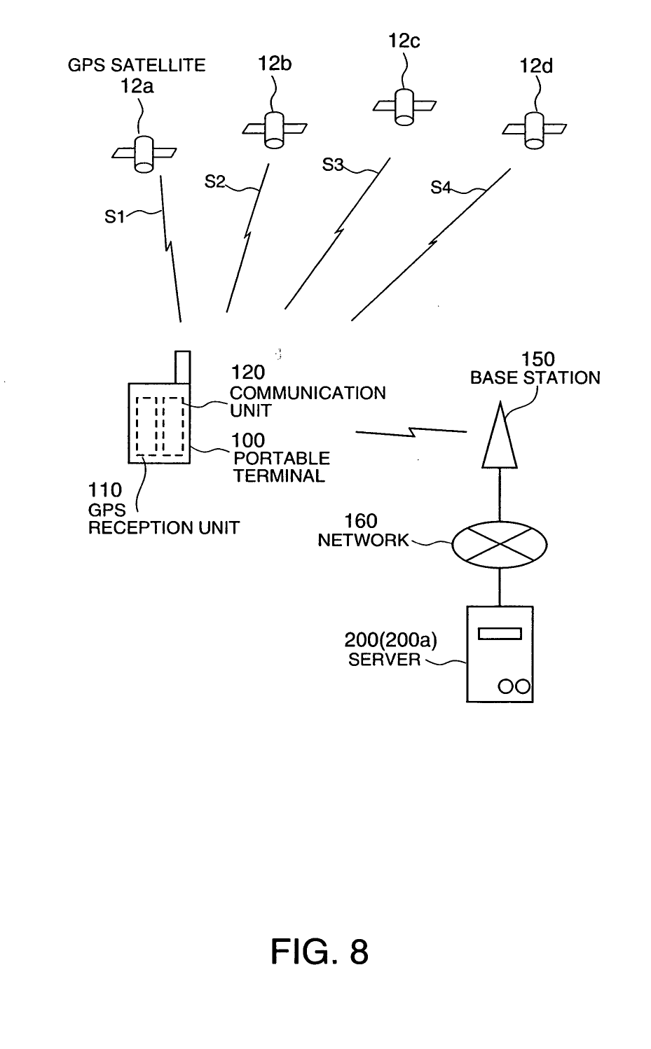

FIG. 8 is a schematic diagram showing the environment in which a portable terminal 100, which is a GPS receiver and is also an example of the receiver, is used.

The portable terminal 100 has a GPS reception unit 110 that performs positioning using the signals S1 and so forth that are transmitted from the GPS satellites 12a and so forth.

The portable terminal 100 also has a communication unit 120 that performs communication with a server 200 through a base station 150 and a network 160 to acquire a corrected C/A code from the server 200.

Configuration of the Portable Terminal 100

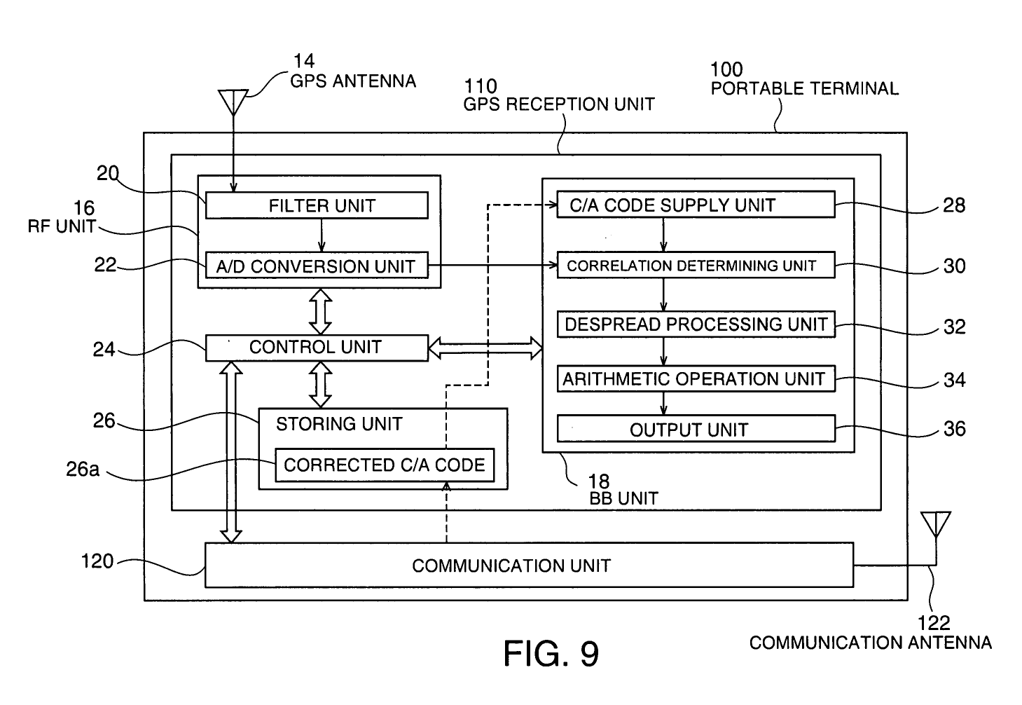

FIG. 9 is a schematic diagram showing the configuration of the portable terminal 100.

The portable terminal 100 has a GPS receiving unit 110 and a communication unit 120. The GPS receiving unit 110 includes the RF unit 16, the BB unit 18, the control unit 24, and the storing unit 26. Basic configuration of the units of the GPS receiving unit 110 is the same as that in the GPS receiver 10 in FIG. 2.

A communication unit 120, which is an example of the communication unit, is constituted by, for example, a cellular phone communication apparatus. The communication unit 120 can transmit and receive radio waves with a communication antenna 122 and communicate with the base station 150.

The portable terminal 100 acquires the corrected C/A code 26a from the server 200 using the communication unit 120 and stores the corrected C/A code 26a in the storing unit 26.

Configuration of the Portable Terminal 100

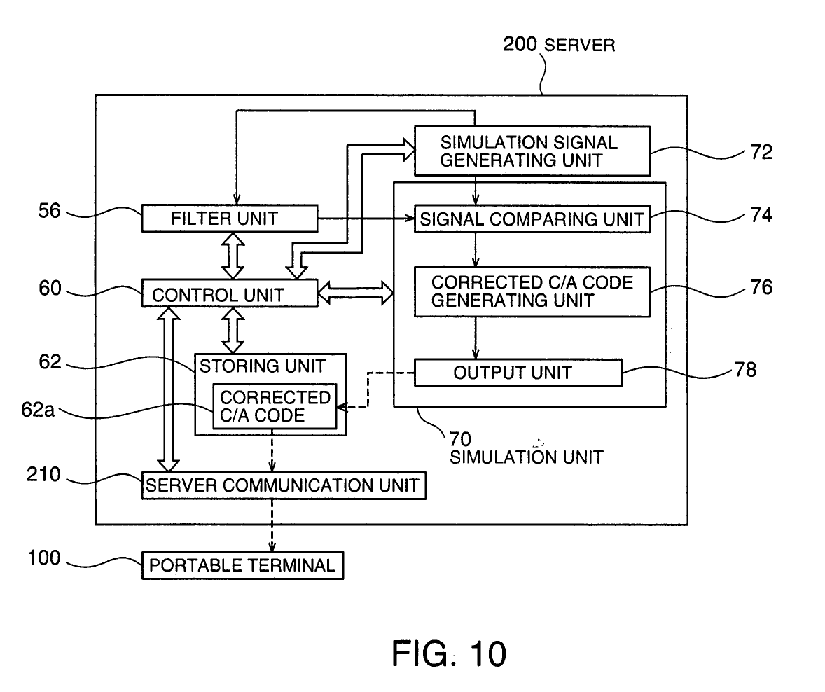

FIG. 10 is a schematic diagram showing a configuration of the server 200, which is an example of the information providing apparatus.

The server 200 is, for example, a File Transfer Protocol (FTP) server and includes the simulation signal generation unit 72, the filter unit 56, the control unit 60, the storing unit 62, and the simulation unit 70. Configurations and operations of these units are the same as those of the PC 50 shown in FIG. 3. In other words, the server 200 is an example of the information providing apparatus and also an example of the apparatus for generating a despread code.

The server 200 additionally includes a server communication unit 210. The server communication unit 210 is a communication interface that is embodied with, for example, an Ethernet adapter. In this embodiment, the server 200 can also make wire connection to the base station 150 through the network 160.

The server 200 always waits for an information transfer request from a client such as the portable terminal 100. When an information transfer request is detected, the server 200 transmits the corrected C/A code 62a stored in the storing unit 62 to the portable terminal 100 through the server communication unit 210.

In this way, the corrected C/A code 62a is stored in the server 200 and managed solely by the server 200. Thus, when there is a change in the corrected C/A code 62a, it is possible to reflect the change on the portable terminal 100 promptly.

If the portable terminal 100 is configured to obtain the corrected C/A codes of some of the GPS satellites used for positioning from the server 200 every time the portable terminal 100 performs positioning, the portable terminal 100 does not have to store the corrected C/A codes for all the GPS satellites. Therefore, it is possible to save a storage area in the portable terminal 100.

Modification of Server 200

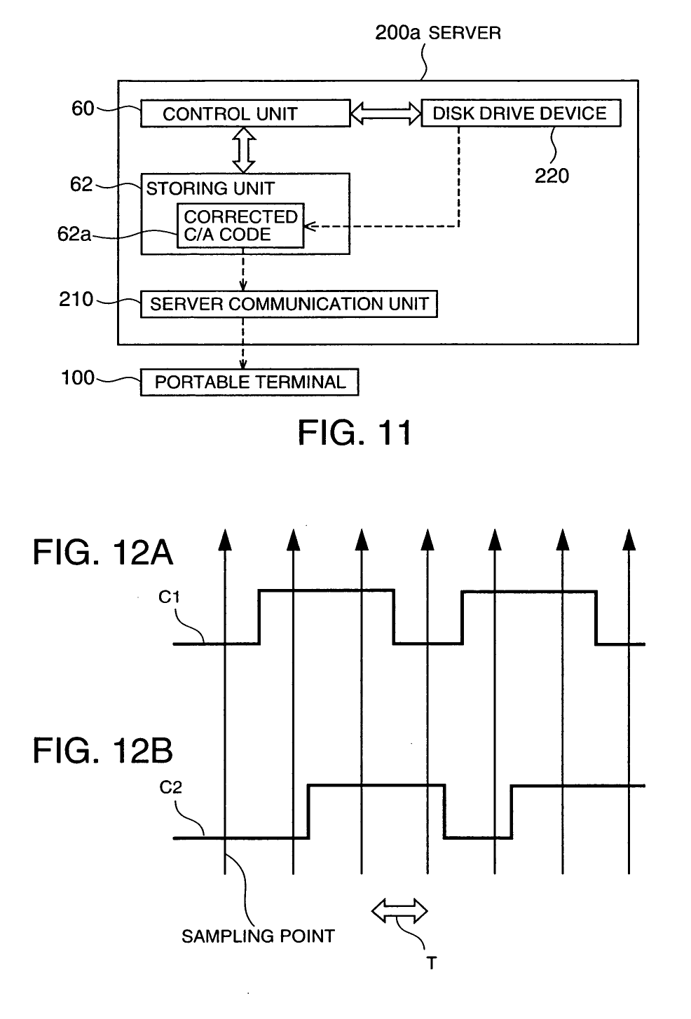

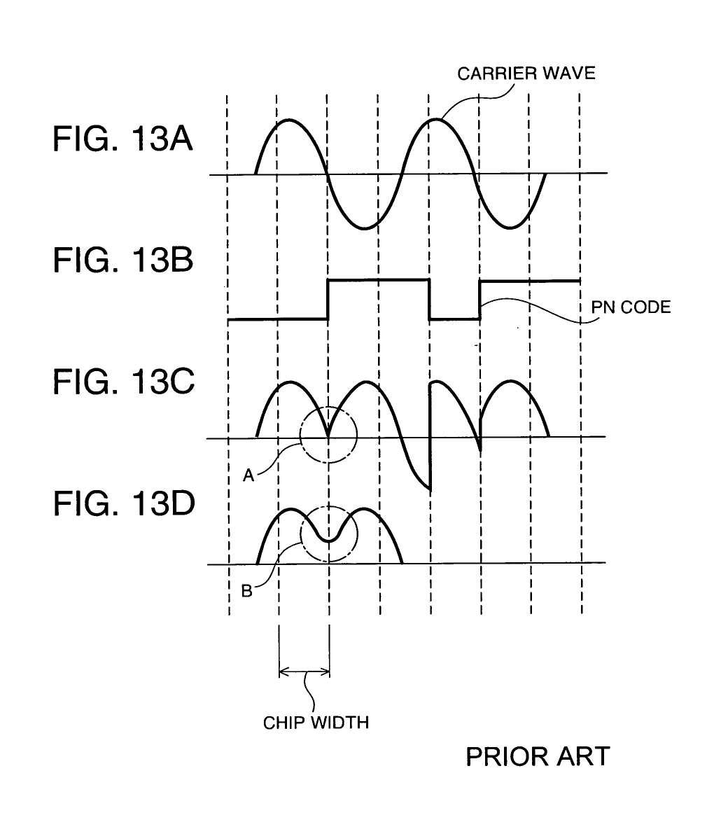

FIG. 11 is a schematic diagram showing the configuration of a server 200a, which is a modification of the server 200.

Unlike the server 200, the server 200a does not have a function of generating a corrected C/A code. Therefore, the server 200a reads a corrected C/A code, which is generated by another apparatus with a disk drive device 220 and recorded on a recording medium such as a CD-R, and stores the corrected C/A code in the storing unit 62. Examples of the apparatus that generates a corrected C/A code include the apparatus for generating a despread code such as the PC 50 in FIG. 3.

With this configuration, it is possible to provide the client such as the portable terminal 100 with the corrected C/A code 62a without having to add a specific structure to a general purpose server.

The scope of the invention is not limited to the embodiments described above. Particularly, the embodiments described above may be combined with one another.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2004-345447. The entire disclosure of Japanese Patent Application No. 2004-345447 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A receiver that is configured to receive a transmission signal, the transmission signal being modulated in Direct Sequence Spread Spectrum using a spread code, the receiver comprising:
a signal receiving unit that is configured to receive the transmission signal and output a received signal;
a receiver filter unit through which the received signal outputted by the signal receiving unit passes and is outputted as an outputted signal; and
a base band unit that is configured to despread the outputted signal based on a corrected despread code,
the corrected despread code being generated based on the spread code and a deformation position, the deformation position indicating a position in the spread code at which deformation occurs as a result of the received signal passing through the receiver filter unit.

2. The receiver according to claim 1, further comprising
a storing unit configured to store the corrected despread code.

3. The receiver according to claim 2, further comprising
a communication unit,
wherein the receiver is configured to acquire the corrected despread code from an information providing apparatus through a network via the communication unit and store the corrected despread code in the storing unit.

4. The receiver according to claim 1, wherein
the base band unit includes a circuit that is configured to generate the corrected despread code based on the spread code and the deformation position.

5. The receiver according to claim 1, wherein
the transmission signal is a positioning signal transmitted from a satellite positioning system satellite.

6. The receiver according to claim 5, further comprising
a storing unit configured to store the corrected despread code,
the storing unit being configured to store a corrected despread code for each of satellite positioning system satellites that communicate with the receiver.

7. The receiver according to claim 1, further comprising
an A/D conversion unit that converts the outputted signal to generate a digital signal,
the base band unit being configured to despread the digital signal using the corrected despread code.

8. The receiver according to claim 1, wherein
the corrected despread code is generated by inverting a value of the spread code at the deformation position.

9. An apparatus for generating a corrected despread code to be used for demodulating a transmission signal, the transmission signal being modulated in Phase Shift Keying modulation and Direct Sequence Spread Spectrum using a spread code, the apparatus for generating a corrected despread code comprising:
a simulation signal generating unit that is configured to generate a simulation signal modulated in Phase Shift Keying modulation and Direct Sequence Spread Spectrum using the spread code;
an apparatus filter unit through which the simulation signal generated by the simulation signal generating unit passes and is outputted as an outputted simulation signal; and
a corrected despread code generating unit that is configured to compare the simulation signal and the outputted simulation signal and obtain a deformation position which indicates a position in the spread code at which deformation occurs as a result of the simulation signal passing through the apparatus filter unit, the corrected despread code generating unit being further configured to generate a corrected despread code by changing a value of the spread code at the deformation position.

10. The apparatus for generating a corrected despread code according to claim 9, wherein
the corrected despread code is generated by inverting the value of the spread code at the deformation position.

11. A method of generating a corrected despread code to be used for demodulating a transmission signal, the transmission signal being modulated in Phase Shift Keying modulation and Direct Sequence Spread Spectrum using a spread code, the method of generating a corrected despread code comprising:
generating a simulation signal modulated in Phase Shift Keying modulation and Direct Sequence Spread Spectrum using the spread code;
removing a high-frequency component from the simulation signal and generating an outputted simulation signal;
comparing the simulation signal and the outputted simulation signal and obtaining a deformation position, the deformation position indicating a position in the spread code at which deformation occurs as a result of the high-frequency component being removed from the simulation signal; and
generating a corrected despread code by changing a value of the spread code at the deformation position.

12. The method of generating a corrected despread code according to claim 11, wherein
the deformation position is obtained by a numerical analysis performed with a computer program.

13. The method of generating a corrected despread code according to claim 11, wherein
the deformation position is obtained by displaying a waveform of the simulation signal and a waveform of the outputted simulation signal.

14. The method of generating a corrected despread code according to claim 11, wherein
the transmission signal is a positioning signal transmitted from a satellite positioning system satellite, and
the corrected despread code is generated for each of a plurality of satellite positioning system satellites.

15. The method of generating a corrected despread code according to claim 11, wherein
the corrected despread code is generated by inverting the value of the spread code at the deformation position.
